(19) United States
(12) Patent Application Publication
(10) Pub. No.: US 2005/0116597 A1
(43) Pub. Date: Jun. 2, 2005

(54) Light bulb

(76) Inventor: Yung-Hsiang Hsu, Sinjhuang City (TW)

Correspondence Address: Yung-Hsiang Hsu, P.O. Box No. 6-57, Junghe, Taipei, 235, TW

(21) Appl. No.: 10/724,697

(22) Filed: Dec. 2, 2003

(51) Int. Cl. H01J 61/40

(52) U.S. Cl. 313/113

(57) ABSTRACT

A light bulb comprising a structure characterized in having a light reflecting plate and a light-emitting repository configured on a circuit board. Upon the circuit board being disposed in a base of the light bulb, connecting pins are employed to connect the circuit board to the base. After electricity is supplied to entire light-emitting device, rays of light directly emitting from the light-emitting repository are rectified by means of an elevation of the light reflecting plate, furthermore, an inclined surface of the light reflecting plate is employed to control the rays of light emitted at an angle greater than direct emittance angle, thereby achieving uniform distribution of the rays of light, and thus enhancing brightness and degree of uniformity thereof.

### BACKGROUND OF THE INVENTION

(a) Field of the Invention

The present invention relates to light bulbs, and more particularly to a light bulb comprising a structure characterized in having a light reflecting plate and a light-emitting repository configured on a circuit board.

(b) Description of the Prior Art

All conventional light bulbs utilize a tungsten filament as a light-emitting source. However, after the light bulb has been switched on for a period of time, a high temperature is produced therefrom, which unquestionably shortens life of the light bulb, and easily results in a user inadvertently being burnt. Moreover, rays of light emitting from the tungsten filament are scattered in uniformity upon projecting onto a surface of the light bulb, easily resulting in a non-uniform distribution of the rays of light.

Furthermore, structure of present energy saving light bulbs is similar to a light-emitting structure of a general fluorescent light, whereby high-speed electron bombardment produces ultraviolet light, which thereon passes through a fluorescent coating and emits light therefrom. However, after the light bulb has been switched on for a period of time, a high temperature is still produced therefrom. Moreover, electric power required by the high-speed electron bombardment is relatively large, and has limited energy saving effectiveness.

Wherefore, providing a light bulb capable of producing uniform illumination, and low electrical energy consumption are technical difficulties, which the inventor of the present invention wishes to resolve in disclosures described herein.

### SUMMARY OF THE INVENTION

The present invention provides an improved light bulb structure having a light reflecting plate and a light-emitting repository configured on a circuit board.

Upon the circuit board being disposed in a base of the light bulb, connecting pins are employed to connect the circuit board to the base. After electricity is supplied to entire light-emitting device, rays of light directly emitting from the light-emitting repository are rectified by means of an elevation of the light reflecting plate, furthermore, an inclined surface of the light reflecting plate is employed to control the rays of light emitted at an angle greater than direct emittance angle, thereby achieving uniform distribution of the rays of light, and thus enhancing brightness and degree of uniformity thereof.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows an elevational view according to the present invention.

FIG. 2 shows an exploded elevational view according to the present invention.

FIG. 3 shows a cutaway view according to the present invention.

FIG. 4 shows a cross sectional schematic view of emitting rays of light according to the present invention.

FIG. 5 shows a cross sectional schematic view of another embodiment of emitting rays of light according to the present invention.

FIG. 6 shows a cross sectional schematic view of yet another embodiment of emitting rays of light according to the present invention.

### DETAILED DESCRIPTION OF THE PREFERRED EMBODIMENTS

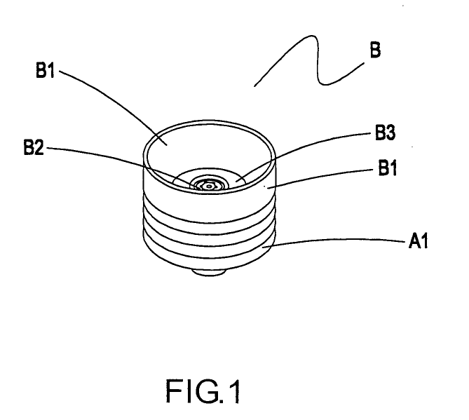

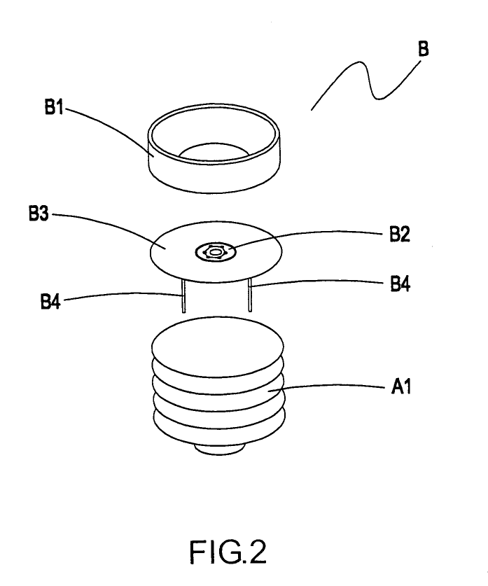

Referring to FIGS. 1 and 2, comprises a structure characterized in having a light reflecting plate B1 and a light-emitting repository B2 configured on a circuit board B3. Upon the circuit board B3 being disposed in a base A1 of the light bulb, connecting pins B4 are employed to connect the circuit board B3 to the base A1. After electricity is supplied to entire light-emitting device B, rays of light directly emitting from the light-emitting repository B2 are rectified by means of an elevation of the light reflecting plate B1, furthermore, an inclined surface of the light reflecting plate B1 is employed to control the rays of light emitted at an angle greater than direct emittance angle, thereby achieving uniform distribution of the rays of light, and thus enhancing brightness and degree of uniformity thereof.

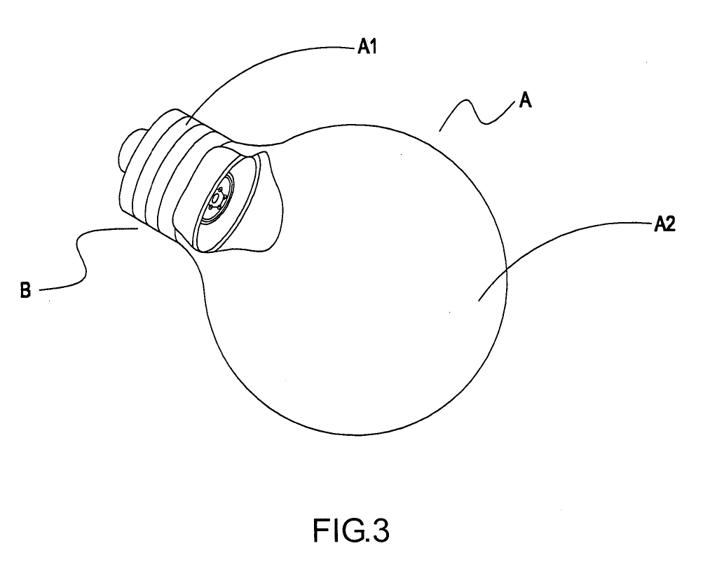

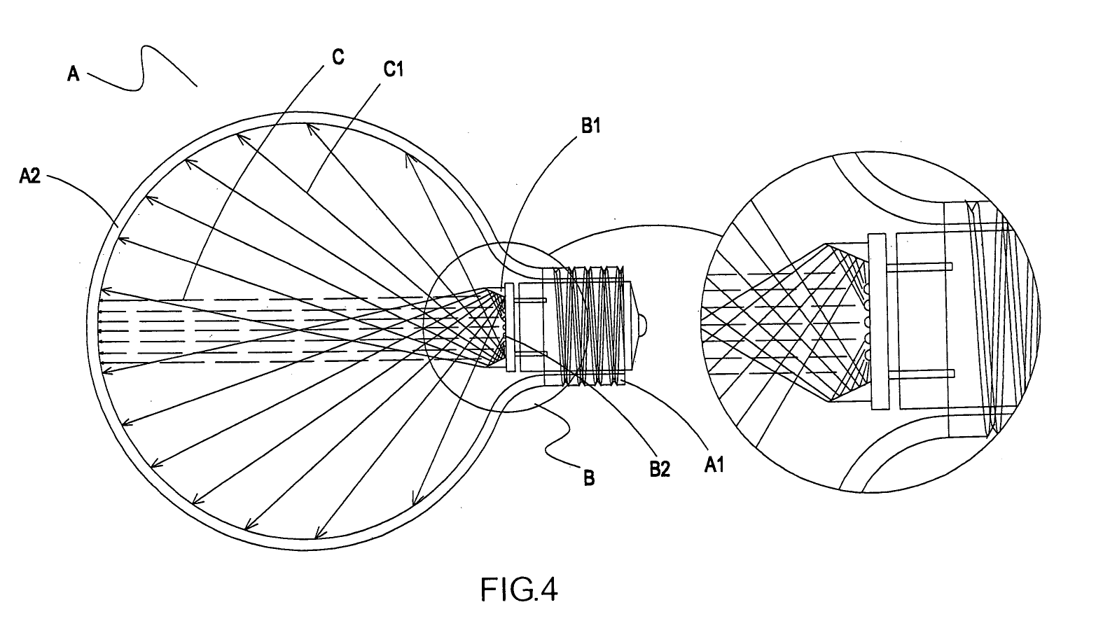

Referring to FIGS. 3 and 4, which show the light-emitting device B configured within the base A1 of the light bulb A. Upon electricity being supplied to the light bulb A, rays of light C emit from the light-emitting repository B2, and, after undergoing rectification of light path through deflection from the inclined surface of the light reflecting plate B1, the rays of light C uniformly project on to a bulb A2. The rays of light C emitting from the light bulb A thereof provide excellent brightness and degree of uniformity.

A plurality of light-emitting elements may be adapted to enhance brightness of illumination, thereby enabling the light-emitting repository B2 so formed to achieve a uniform equivalent light source.

Wherein the light-emitting repository B2 comprises and is constructed to include a light-emitting diode, an incandescent diode, a small-scale light bulb, and other related light source elements applied in illumination components.

Wherein the light-emitting device B is installed in an autocar lamp, lighting employed indoors or outdoors, street lighting, a desk lamp, and other related illumination sources applied in lighting equipment.

Wherein the bulb A2 includes a transparent covering, a fluorescent-coated material covering, a ground material covering and other related coverings applied in exterior coverings of light bulbs. An embodiment of the present invention provides an improved light bulb, wherein, as FIGS. 3 and 4 show, a light-emitting device B is configured within a base A1 of a light bulb A. Upon electricity being supplied to the light bulb A, rays of light C emit from the light-emitting repository B2, and, after undergoing rectification of light path through deflection from an inclined surface of a light reflecting plate B1, the rays of light C uniformly project on to a surface of a bulb A2. The rays of light C emitting from the light bulb A thereof provide excellent brightness and degree of uniformity.

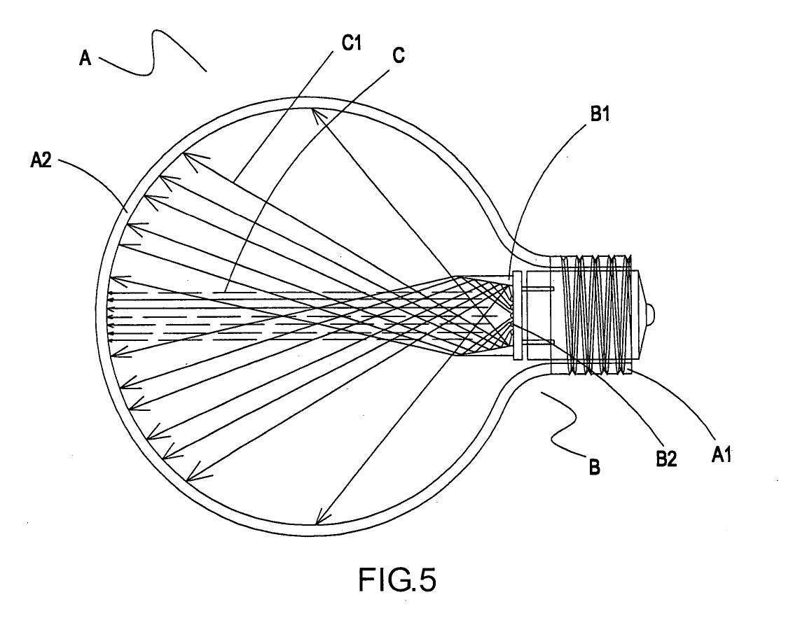

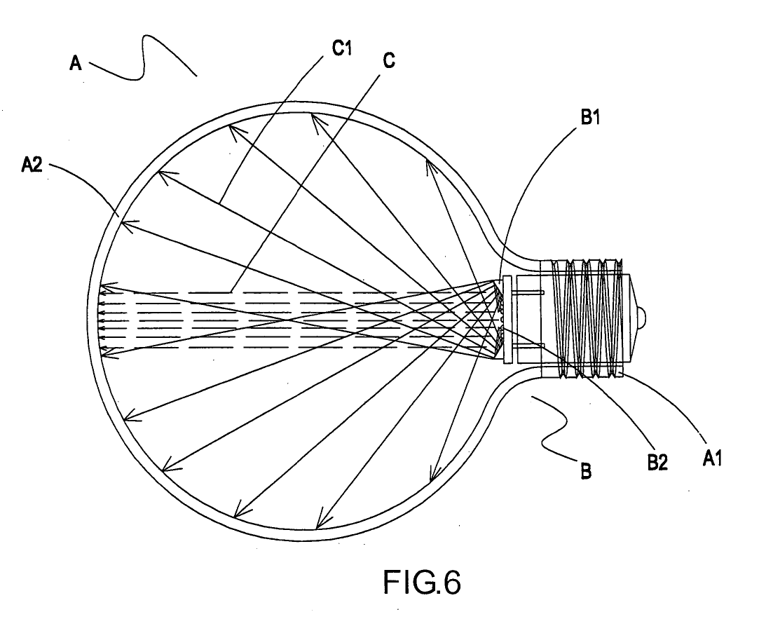

Referring to FIGS. 5 and 6, which show the rays of lights emitting from the light-emitting repository B2, and by means of an elevation of the light reflecting plate B1 or after undergoing deflection at differing angles from the inclined surface of the light reflecting plate B1, control is achieved of area and brightness of the bulb A2 upon which the rays of light are projected onto, as well as accomplishing unnecessary changing of a light source and the bulb A2, thereby diminishing production costs.

In order to further clarify advancement and practicability of the present invention, a comparative analysis with a conventional light bulb is disclosed hereinafter:

Imperfections of a conventional light bulb:

1. Easily produces a high temperature, resulting in a user inadvertently getting burnt.

2. Prolonged usage at a high temperature easily shortens life of the light bulb and a tungsten filament.

3. High electricity consumption, easily resulting in wastage of electric power.

4 An energy saving light bulb is filled with a large quantity of chemical materials, which, upon the light bulb fracturing, causes harm to a human body.

5. Energy saving effectiveness of the energy saving light bulb is limited, and thus difficult to effectively save on electric power.

6. Brightness and degree of uniformity are imperfect, and illumination effectiveness is limited.

Advantages of the present invention:

1. Employs rays of light emitting from a light-emitting repository to achieve uniformity of intensity of the rays of light.

2. Adapts the light-emitting repository as the light source to achieve low electrical power consumption.

3. Employs a light reflecting plate to correct angle of emittance of the rays of light, thereby enhancing degree of focusing of the rays of light.

4. Excellent degree of uniformity and brightness of the emitted rays.

5. Provides advancement and practicability.

6. Advances industrial competitiveness.

In conclusion, the present invention is a breakthrough in prior art techniques, and assuredly achieves effectiveness of intended advancement. Moreover, persons not familiar with the art as revealed herein may easily understand disclosures as described. Furthermore, the present invention has not been made public before patent application as disclosed herein. The advancement and practicability of the present invention evidently complies with conditions for applying for a new model patent; accordingly a patent application is submitted herein.

It is of course to be understood that the embodiments described herein is merely illustrative of the principles of the invention and that a wide variety of modifications thereto may be effected by persons skilled in the art without departing from the spirit and scope of the invention as set forth in the following claims.

1. A light bulb comprising a structure comprising a light reflecting plate and a light-emitting repository configured on a circuit board, and upon the circuit board being disposed in a base of the light bulb, connecting pins are employed to connect the circuit board to the base; after electricity is supplied to entire light-emitting device, rays of light directly emitting from the light-emitting repository are rectified by means of an elevation of the light reflecting plate, furthermore, an inclined surface of the light reflecting plate is employed to control the rays of light emitted at an angle greater than direct emittance angle, thereby achieving uniform distribution of the rays of light, and thus enhancing brightness and degree of uniformity thereof.

2. The light bulb as claimed in claim 1, wherein the light-emitting repository comprises and is constructed to include a light-emitting diode, an incandescent diode, a small-scale light bulb, and other related light source elements applied in illumination components.

3. The light bulb as claimed in claim 1, wherein the light-emitting device is installed in an autocar lamp, lighting employed indoors or outdoors, a street lighting, a desk lamp, and other related illumination sources applied in lighting equipment.

4. The light bulb as claimed in claim 1, wherein the bulb includes a transparent covering, a fluorescent-coated material covering, a ground material covering and other related coverings applied in exterior coverings of light bulbs.

5. The light bulb as claimed in claim 1, wherein the light reflecting plate is further configured with light reflecting plates adapted as an elevation and an inclined surface defined at differing angles, thereby facilitating changing area and brightness of the bulb upon which the rays of light are projected onto.
